(19) United States
(12) Patent Application Publication
(10) Pub. No.: US 2020/0330295 A1
(43) Pub. Date: Oct. 22, 2020

(54) MOBILITY DEVICE LIFT SYSTEM

(71) Applicant: Guy Baron, Aurora, CO (US)

(72) Inventor: Guy Baron, Aurora, CO (US)

(21) Appl. No.: 16/278,012

(22) Filed: Feb. 15, 2019

Related U.S. Application Data
(60) Provisional application No. 62/631,178, filed on Feb. 15, 2018.

(51) Int. Cl. A61G 3/06; B66F 9/075; B66F 9/19; B66F 9/18

(52) U.S. Cl. CPC A61G 3/063; B66F 9/07568; B66F 9/18; B66F 9/19; B66F 9/07586

(57) ABSTRACT

A mobility device lift system including an electric pallet jack having a handle, a pallet, a ramp, a vertical lifting mechanism, and a wheel assembly. The pallet is sized and functionally configured to support a mobility device thereon. The pallet is affixed to the vertical lifting mechanism, such that the pallet is able to move up and down vertically via hydraulics of the vertical lifting mechanism. The electric pallet jack is configured for transporting the mobility device from a loading bridge to a belt loader. The ramp of the device provides a connector between the loading bridge and the belt loader.

### CROSS REFERENCE TO RELATED APPLICATION

The present application is related to and claims priority to U.S. Provisional Patent Application No. 62/631,178 filed Feb. 15, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of lift devices and more specifically relates to an electric lift device.

### 2. Description of Related Art

Safety mechanisms are built into the wheels of motorized wheelchairs and scooters that causes them to lock up in the off position, making it difficult for people to push them onto and off of loading ramps. Doing so can even place strain on a person's back or cause other painful injuries. Some people may turn on chairs or scooters on, but this can drain the battery. Additionally, most people push mobility devices from the side, which can be hazardous to other people nearby. A suitable solution is desired.

U.S. Pat. No. 5,105,915 to Jerry M. Gary relates to a wheelchair lifting device. The described wheelchair lifting device includes a wheelchair lift that consists of a horizontal platform mounted on a hydraulic elevator operable by the wheelchair occupant. A pivotable back panel of the platform provides a ramp for access to its top from ground level when the elevator frame is completely contracted, and the platform is at its lowest position. The back ramp, together with a front gate and a system of lateral rails insures the stability and safety of the wheelchair on top of the platform, which can then be raised to the desired height by the occupant. The elevator arrangement is designed for fast response, so that the invention can be effectively used not only to move a wheelchair to a different plane for locomotion, but also for applications that require frequent adjustments to different heights.

### BRIEF SUMMARY OF THE INVENTION

In view of the foregoing disadvantages inherent in the known lift device art, the present disclosure provides a novel mobility device lift system. The general purpose of the present disclosure, which will be described subsequently in greater detail, is to provide a new and improved way of lifting a mobility device to a variable height.

A mobility device lift system is disclosed herein. The mobility device lift system includes an electric pallet jack having a handle, a pallet, a ramp, a vertical lifting mechanism, and a wheel assembly. The electric pallet jack is steerable via the handle. The pallet is sized and functionally configured to support a mobility device thereon. The pallet is affixed to the vertical lifting mechanism, such that the pallet is able to move up and down vertically via hydraulics of the vertical lifting mechanism. The ramp is hingedly connected to the pallet. The ramp is configured to lock in an upright position and alternatively to unlock to provide a ramp for loading the mobility device. In a preferred embodiment, the pallet and the ramp comprise aluminum. The pallet is connected to and is configured to move along a track of the vertical lifting mechanism. The electric pallet jack is configured for transporting the mobility device from a loading bridge to a belt loader.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a mobility device lift system, constructed and operative according to the teachings of the present disclosure.

FIG. 1 is a perspective view of the mobility device lift system during an ‘in-use’ condition, according to an embodiment of the disclosure.

FIG. 2 is a perspective view of the mobility device lift system of FIG. 1, according to an embodiment of the present disclosure.

FIG. 3 is a perspective view of the mobility device lift system of FIG. 1, according to an embodiment of the present disclosure.

FIG. 4 is a perspective view of the mobility device lift system of FIG. 1, according to an embodiment of the present disclosure.

FIG. 5 is a perspective view of the mobility device lift system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to lift devices and more particularly to a mobility device lift system as used to improve the transportation of mobility devices from a loading bridge to a belt loader with ease and safety.

Generally, the mobility device lift system provides an efficient, safe way to transport wheelchairs, scooters, and more from a loading bridge to a belt loader. The device may comprise an electric warehouse lift with a specially designed pallet, preferably made from lightweight aluminum. The bottom of the pallet can have a jagged surface with holes to prevent moisture buildup. Additionally, the pallet has a flap that folds down and rests on the conveyor belt of a belt loader. On the backside of the flap can be a roller. The device effectively eliminates the need to manually push devices from the side, which can cause stress and strain on the body, especially if the wheels lock up. It spares the battery life of mobility devices, preventing them from dying. The present invention saves a considerable amount of time and frustration.

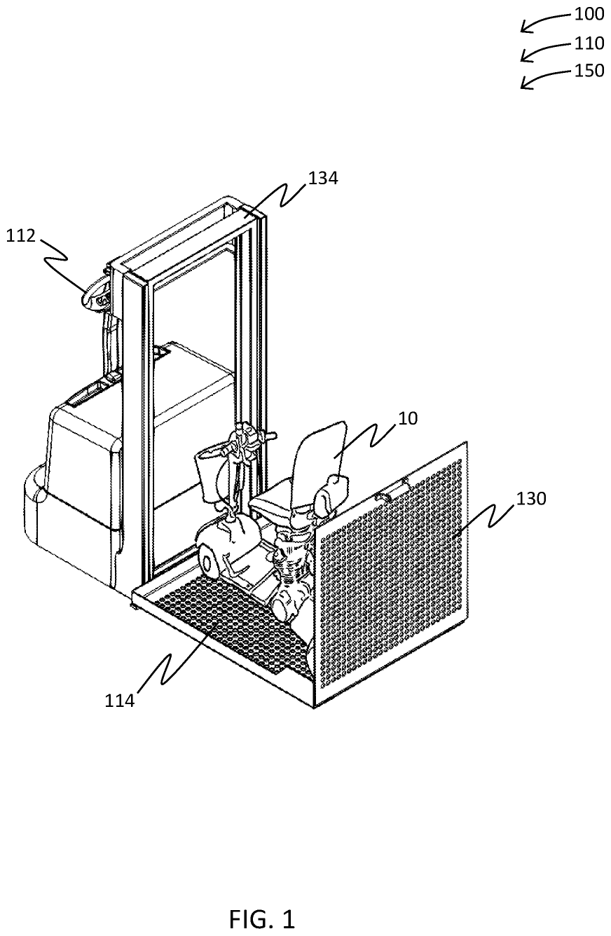

Referring now more specifically to the drawings by numerals of reference, there is shown in FIGS. 1-5, various views of a mobility device lift system 100. FIG. 1 shows a mobility device lift system 100 during an ‘in-use’ condition 150, according to an embodiment of the present disclosure. As illustrated, the mobility device lift system 100 may include an electric pallet jack 110 having a handle 112, a pallet 114, a ramp 130, a vertical lifting mechanism 134, and a wheel assembly 140. The electric pallet jack 110 is steerable via the handle 112. The pallet 114 is sized and functionally configured to support a mobility device 10 thereon. The pallet 114 is affixed to the vertical lifting mechanism 134, such that the pallet 114 is able to move up and down vertically via hydraulics of the vertical lifting mechanism 134. The ramp 130 is hingedly connected to the pallet 114. The mobility device lift system 100 is configured for transporting mobility device 10 from a loading bridge to a belt loader. The ramp 130 provides a connector between the loading bridge and the belt loader.

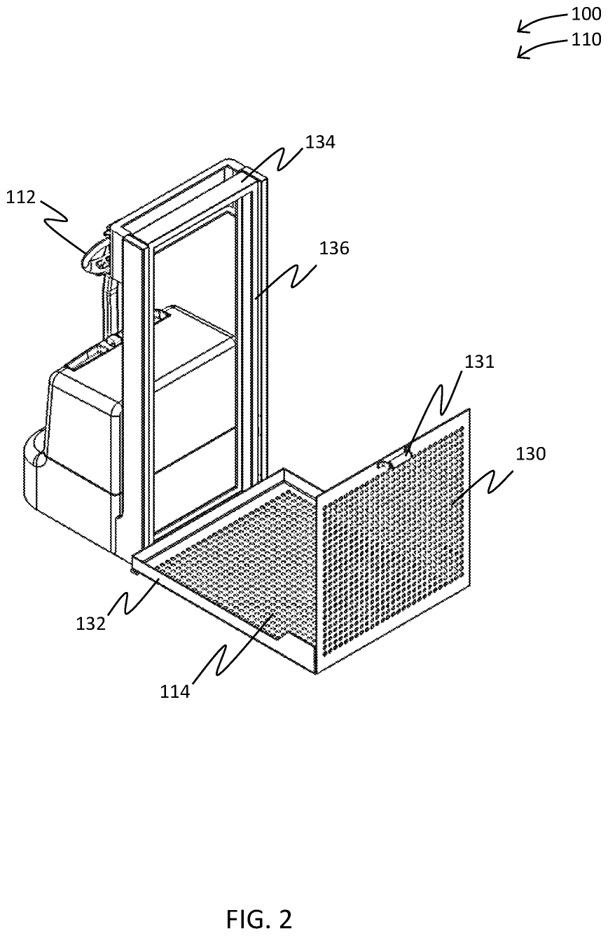

FIG. 2 shows a perspective view of the mobility device lift system 100 of FIG. 1, according to an embodiment of the present disclosure. As above, the mobility device lift system 100 may include the electric pallet jack 110 configured to assist in transporting a mobility device 10. In a preferred embodiment, the pallet 114 preferably comprises aluminum. The pallet 114 may include a perforated aluminum sheet. The pallet 114 is defined by a top surface 116 and a bottom surface 118. The top surface 116 is planar. The bottom surface 118 comprises a jagged surface having a series of apertures 120 to prevent moisture build-up. The pallet 114 is further defined by a first-side 122, a second-side 124, a third-side 126 and a fourth-side 128. The ramp 130 is positioned at the fourth-side 128 opposing the vertical lifting mechanism 134. The pallet 114 further comprises a border 132 at the first-side, the second-side, and the third-side, defining a partial perimeter of the pallet 114.

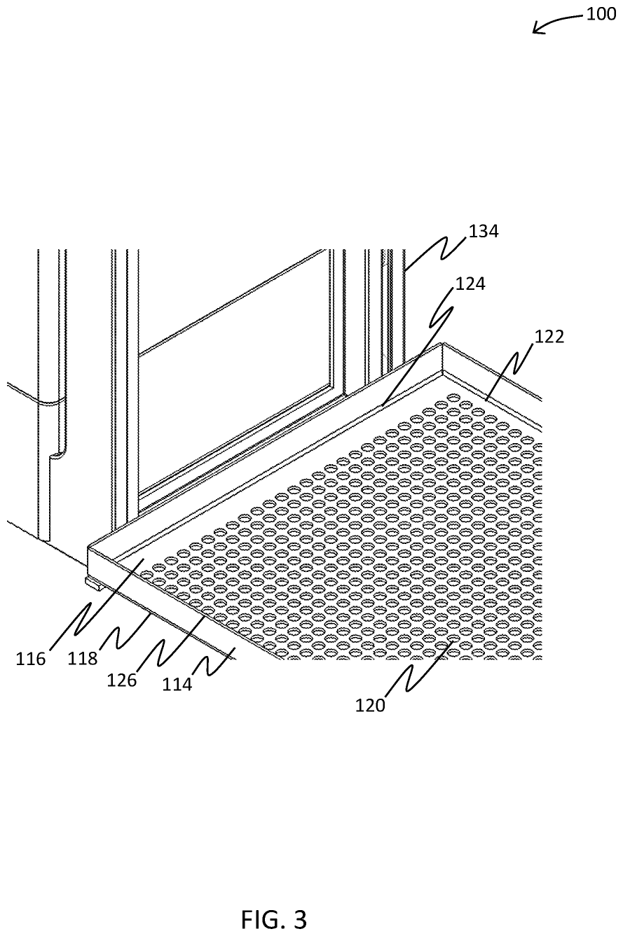

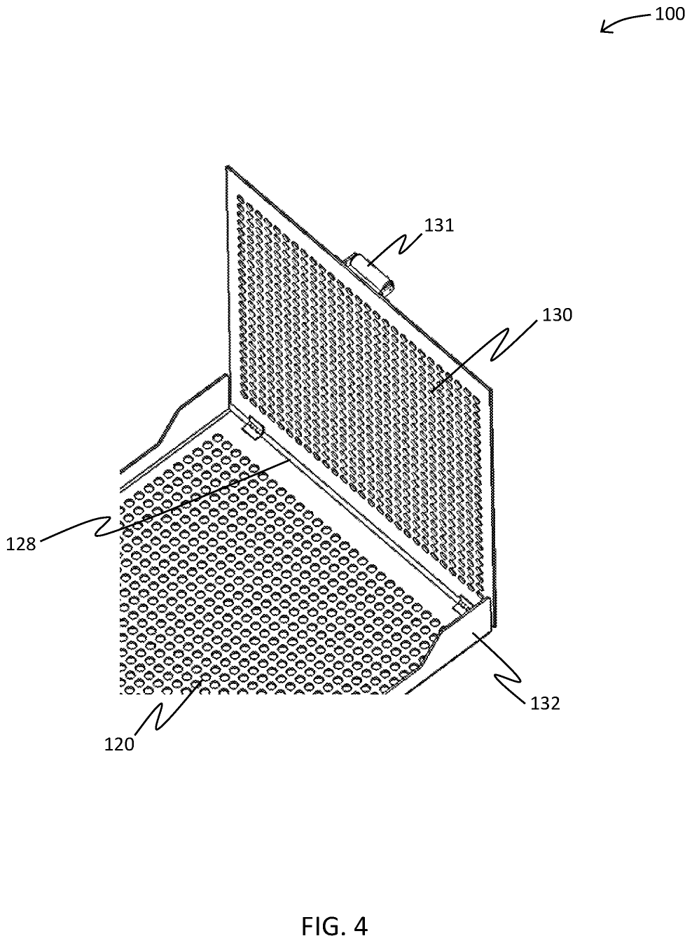

FIGS. 3-4 show perspective views of the mobility device lift system 100 of FIG. 1, according to an embodiment of the present disclosure. As above, the mobility device lift system 100 may include the electric pallet jack 110 having the handle 112, the pallet 114, the ramp 130, the vertical lifting mechanism 134, and the wheel assembly 140. The pallet 114 comprises a substantially square profile. The pallet 114 is connected to and is configured to move along a track 136 of the vertical lifting mechanism 134. The pallet 114 is connected to the track 136 at the second-side 124. The electric pallet jack 110 is configured to lift a weight of the mobility device 10 to various heights and support the weight of the mobility device 10 on the pallet 114.

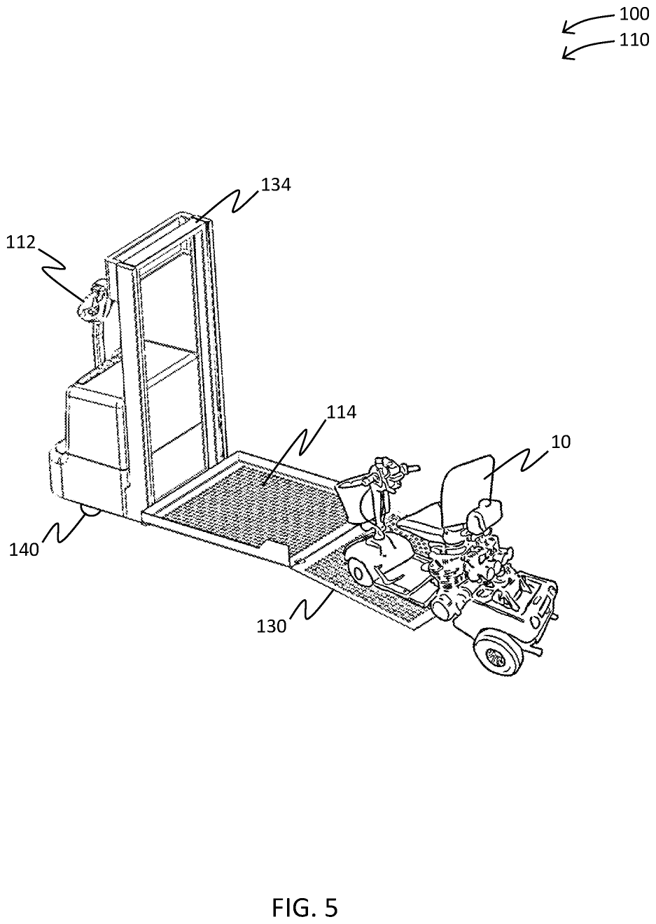

FIG. 5 shows a perspective view of the mobility device lift system 100 of FIG. 1, according to an embodiment of the present disclosure. As above, the mobility device lift system 100 may include the electric pallet jack 110 which is configured for transporting the mobility device 10 from a loading bridge to a belt loader. The ramp 130 is configured to lock in an upright position and alternatively unlock to provide a ramp 130 for loading the mobility device 10. The ramp 130 provides a connector between the loading bridge and the belt loader. The ramp 130 comprises a substantially square profile and also comprises aluminum. The ramp 130 comprises a perforated aluminum sheet similar to the pallet 114. The ramp 130 further comprises a roller 131 positioned on a ramp-bottom-surface.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A mobility device lift system comprising:
an electric pallet jack having;
a handle;
a pallet;
a ramp;
a vertical lifting mechanism; and
a wheel assembly;
wherein said electric pallet jack includes said handle, said pallet, and said ramp;
wherein said electric pallet jack is steerable via said handle;
wherein said pallet is sized and functionally configured to support a mobility device thereon;
wherein said pallet is affixed to said vertical lifting mechanism, such that said pallet is able to move up and down vertically via hydraulics of said vertical lifting mechanism; and
wherein said ramp is hingedly connected to said pallet.

2. The mobility device lift system of claim 1, wherein said pallet comprises aluminum.

3. The mobility device lift system of claim 2, wherein said pallet comprises a perforated aluminum sheet.

4. The mobility device lift system of claim 3, wherein said pallet comprises top surface and a bottom surface, said top surface is planar.

5. The mobility device lift system of claim 4, wherein said bottom surface comprises a jagged surface having a series of apertures to prevent moisture build-up.

6. The mobility device lift system of claim 4, wherein said pallet comprises a first-side, a second-side, a third-side and a fourth-side.

7. The mobility device lift system of claim 6, wherein said ramp is positioned at said fourth-side opposing said vertical lifting mechanism.

8. The mobility device lift system of claim 6, wherein said pallet further comprises a border at said first-side, said second-side, and said third-side, defining a partial perimeter of said pallet.

9. The mobility device lift system of claim 6, wherein said pallet comprises a substantially square profile.

10. The mobility device lift system of claim 7, wherein said pallet is connected to and is configured to move along a track of said vertical lifting mechanism, said pallet is connected to said track at said second-side.

11. The mobility device lift system of claim 1, wherein said electric pallet jack is configured to lift and support a weight of said mobility device on said pallet.

12. The mobility device lift system of claim 1, wherein said ramp is configured to lock in an upright position and alternatively unlock to provide a ramp for loading said mobility device.

13. The mobility device lift system of claim 1, wherein said mobility device lift system is configured for transporting said mobility device from a loading bridge to a belt loader.

14. The mobility device lift system of claim 13, wherein said ramp provides a connector between said loading bridge and said belt loader.

15. The mobility device lift system of claim 1, wherein said ramp comprises a substantially square profile.

16. The mobility device lift system of claim 15, wherein said ramp comprises aluminum.

17. The mobility device lift system of claim 16, wherein said ramp comprises a perforated aluminum sheet.

18. The mobility device lift system of claim 1, wherein said ramp further comprises a roller.

19. The mobility device lift system of claim 18, wherein said roller is positioned on a ramp-bottom-surface.

20. A mobility device lift system, the mobility device lift system comprising:
an electric pallet jack having;
a handle;
a pallet;
a ramp;
a vertical lifting mechanism; and
a wheel assembly;
wherein said electric pallet jack includes said handle, said pallet, and said ramp;
wherein said electric pallet jack is steerable via said handle;
wherein said pallet is sized and functionally configured to support a mobility device thereon;
wherein said pallet is affixed to said vertical lifting mechanism, such that said pallet is able to move up and down vertically via hydraulics of said vertical lifting mechanism;
wherein said ramp is hingedly connected to said pallet;
wherein said pallet comprises aluminum;
wherein said pallet comprises top surface and a bottom surface, said top surface is planar;
wherein said bottom surface comprises a jagged surface having a series of apertures to prevent moisture build-up;
wherein said pallet comprises a first-side, a second-side, a third-side and a fourth-side;
wherein said ramp is positioned at said fourth-side opposing said vertical lifting mechanism;
wherein said pallet further comprises a border at said first-side, said second-side, and said third-side, defining a partial perimeter of said pallet;
wherein said pallet comprises a substantially square profile;
wherein said pallet is connected to and is configured to move along a track of said vertical lifting mechanism, said pallet is connected to said track at said second-side;
wherein said electric pallet jack is configured to lift and support a weight of said mobility device on said pallet;
wherein said ramp is configured to lock in an upright position and alternatively unlock to provide a ramp for loading said mobility device;
wherein said mobility device lift system is configured for transporting said mobility device from a loading bridge to a belt loader;
wherein said ramp provides a connector between said loading bridge and said belt loader;
wherein said ramp comprises a substantially square profile;
wherein said ramp comprises aluminum;
wherein said ramp further comprises a roller; and
wherein said roller is positioned on a ramp-bottom-surface.
